(19) United States
(12) Patent Application Publication
(10) Pub. No.: US 2002/0172538 A1
(43) Pub. Date: Nov. 21, 2002

(54) Keyboard with microphone

(76) Inventor: Chin-Hsiu Hwa, Taipei (TW)

Correspondence Address: Morton J. Rosenberg, Esq., Rosenberg, Klein & Lee, 3458 Ellicott Center Drive - Suite 101, Ellicott City, MD, 21043, US

(21) Appl. No.: 09/860,547

(22) Filed: May 21, 2001

(51) Int. Cl. B41J 5/12

(52) U.S. Cl. 400/472

(57) ABSTRACT

A keyboard assembly comprises a microphone, a keyboard main body and an assembling unit. The microphone has a ball on a distal end thereof. The keyboard main body has a top cover with a rear plate and has a rounded hole on the real plate. The assembling unit has a ball mount corresponding to the rounded hole and receiving the ball therein. The assembling member is locked to the keyboard main body by a plurality of screws.

### FIELD OF THE INVENTION

The present invention relates to a keyboard assembly with a microphone, especially to a keyboard with a microphone, which has adjustable operation angle.

### BACKGROUND OF THE INVENTION

The nowadays computer keyboard are generally equipped with joystick and scrolling wheel besides the existing keyswitch. Moreover, the keyboard may also be equipped with microphone, as voice input is demanded.

FIG. 1 shows a prior art keyboard with microphone for multimedia application. The keyboard 1a has a top cover 10a and a hole (not shown) on rear side of the top cover 10a. The keyboard 1a further has a plurality of guiding grooves (not shown) with equal separation and on a lateral side of the keyboard 1a near the hole. An accommodation room is formed by the hole and guiding groove on the top cover 10a and a sliding stage (not shown) is slidable in the accommodation room. A mounting stage 2a for microphone is pivotally arranged in the sliding stage and a microphone 3a is embedded into the mounting stage 2a. The inclined angle of the microphone 3a can be adjusted according to user's need.

By above arrangement, the microphone 3a can be laterally shifted and rotated in the keyboard 1a to satisfy user's need. However, the above function is achieved by sliding stage and mounting stage 2a, which are complicated. Moreover, the angle swing of the microphone 3a is limited.

### SUMMARY OF THE INVENTION

It is an object of the present invention to provide a keyboard assembly with a microphone, wherein the microphone can be easily assembled and disassembled by an assembling member.

It is another object of the present invention to provide a keyboard assembly with a microphone, wherein the microphone can be tightened by a plurality of screws.

To achieve above object, the present invention provides a keyboard assembly having a microphone, a keyboard main body and an assembling unit. The microphone has a ball on a distal end thereof. The keyboard main body has a top cover with a rear plate and has a rounded hole on the real plate. The assembling unit has a ball mount corresponding to the rounded hole and receiving the ball therein. The assembling unit is locked to the keyboard main body by a plurality of screws.

The various objects and advantages of the present invention will be more readily understood from the following detailed description when read in conjunction with the appended drawing, in which:

### BRIEF DESCRIPTION OF DRAWING

FIG. 1 shows the perspective view of prior art keyboard assembly with a microphone;

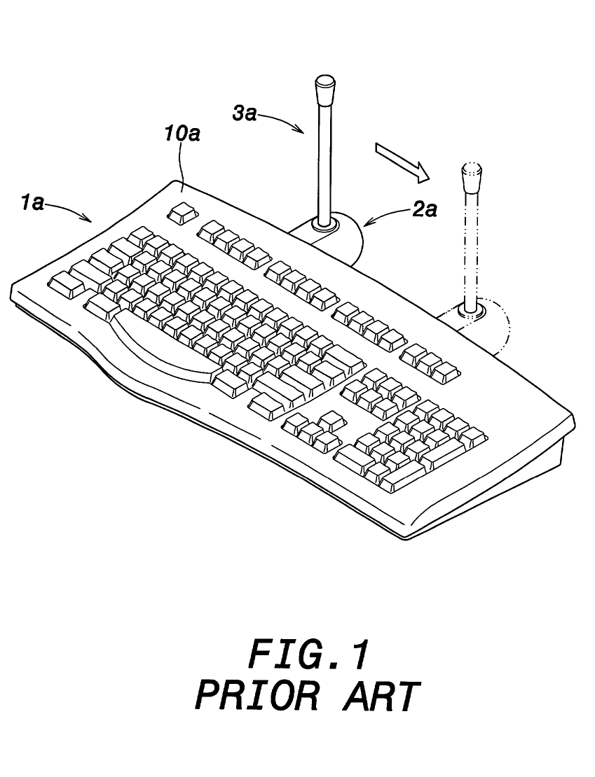

FIG. 2 shows the perspective view of the keyboard assembly with a microphone of the present invention;

FIG. 3 shows the sectional view of the keyboard assembly with a microphone of the present invention;

FIG. 4 shows the perspective view of the assembling part of the present invention;

FIG. 5 shows the keyboard assembly with a microphone of the present invention in a hidden state;

FIG. 6 shows the keyboard assembly with a microphone of the present invention in a operation state.

### DETAILED DESCRIPTION OF THE INVENTION

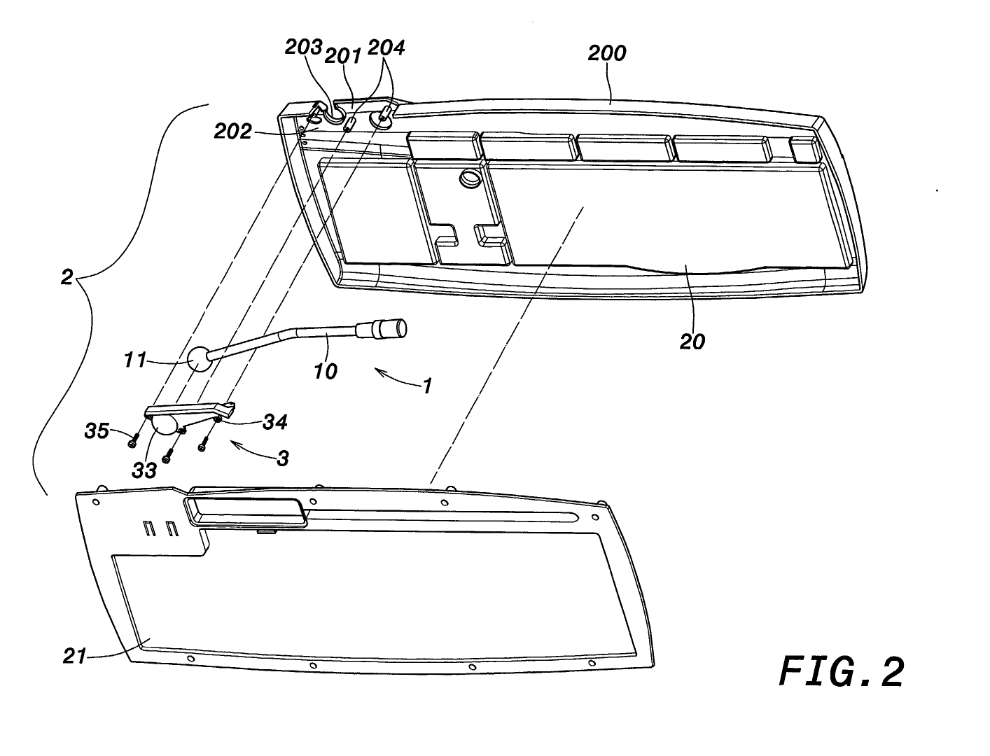

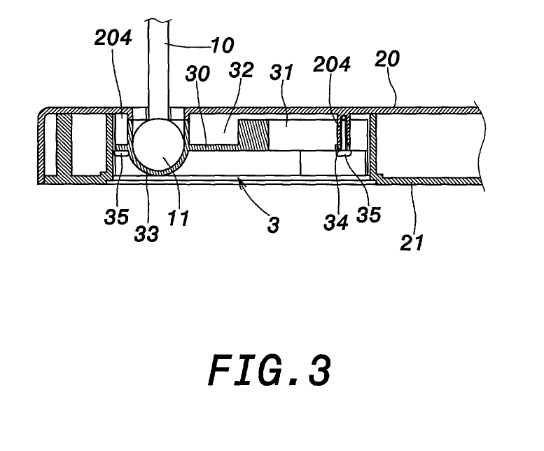

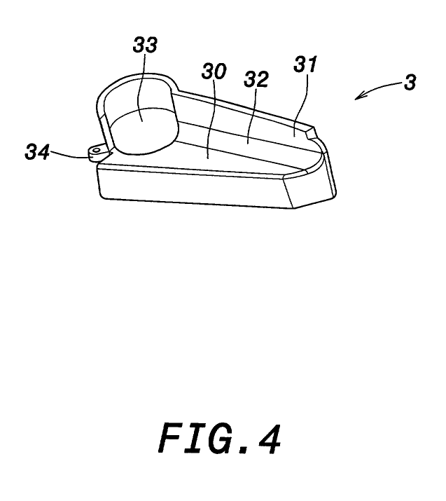

FIGS. 2 and 3 show the exploded view and sectional view the present invention, respectively. The keyboard assembly according to the present invention comprises a microphone 1, a keyboard main body 2 and an assembling unit 3 (as shown in FIG. 4).

The microphone 1 comprises a bent shaft 10 and a ball 11 arranged on distal end of the shaft 10.

The keyboard main body 2 is composed of a top cover 20 and a bottom cover 21. The top cover 20 has a rear wall 200 with a dent 201 thereon and the top cover 20 has a rear plate 202 with a rounded hole 203 communicated with the dent 201. The shaft 10 of the microphone 1 is movable in the dent 201 and the rounded hole 203. The rear plate 202 has a plurality of locking stages 204 near the rounded hole 203.

The assembling unit 3 is composed of a panel 30 and a sidewall 31 to define an accommodating space 32 for microphone 1. The panel 30 has a concave ball mount 33 on one side thereof; the concave ball mount 33 receives the ball 11 therein. The assembling unit 3 has a plurality of locking holes 34 corresponding to the plurality of locking stages 204. The assembling unit 3 can be locked on the keyboard main body 2 by a plurality of locking members 35 such as screws or pins. The separation between the assembling unit 3and the keyboard main body 2 can also be adjusted by the locking members 35.

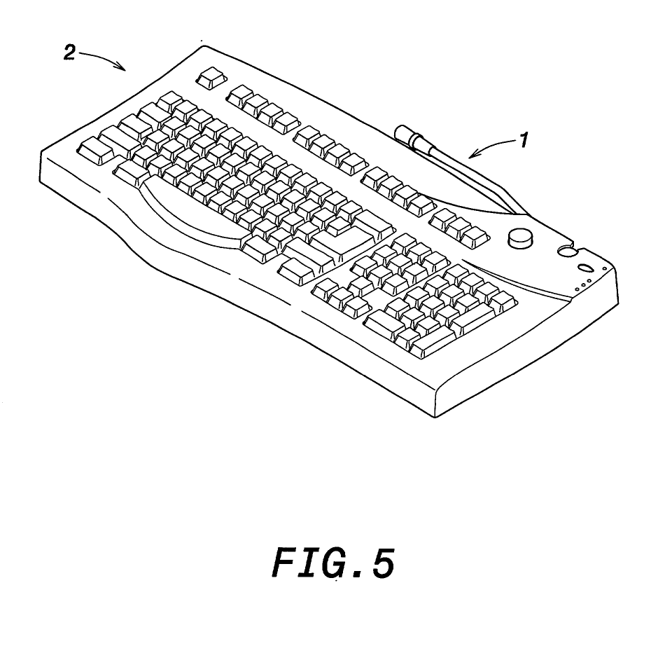

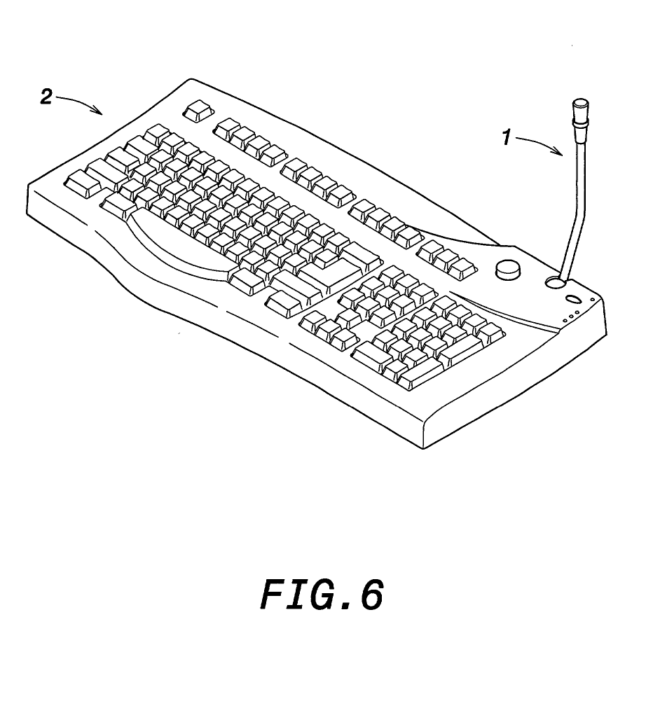

As shown in FIGS. 5 and 6, the ball 11 of the microphone 1 is rotated within the ball mount 33 of the assembling unit 3, thus adjusting the angle of the microphone 1. The microphone 1 exposes out of the keyboard main body 2 through the rounded hole 203 and the shaft 10 of the microphone 1 can be horizontally placed in the accommodating space 32 to hide the microphone 1.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A keyboard assembly with a microphone, comprising
a microphone having a ball on a distal end thereof;
a keyboard main body having a top cover with a rear plate and having a rounded hole on the real plate; and
an assembling unit having a ball mount corresponding to the rounded hole and receiving the ball therein; the assembling unit locked to the keyboard main body by a plurality of locking members.

2. The keyboard assembly with a microphone as in claim 1, wherein the rear plate has a plurality of locking stages near the rounded hole and the assembling unit has a plurality of locking holes corresponding to the locking stages.

3. The keyboard assembly with a microphone as in claim 1, wherein the locking member is screw or pin.
